(19) United States
(12) Patent Application Publication
(10) Pub. No.: US 2022/0230482 A1
(43) Pub. Date: Jul. 21, 2022

(54) RATING SYSTEM FOR DRIVER PERFORMANCE USING PASSENGER DATA

(71) Applicants: Ravikanth Kothuri, Frisco, TX (US); Ananth S. Kothuri, Frisco, TX (US); Maadhav S. Kothuri, Frisco, TX (US)

(72) Inventors: Ravikanth Kothuri, Frisco, TX (US); Ananth S. Kothuri, Frisco, TX (US); Maadhav S. Kothuri, Frisco, TX (US)

(73) Assignee: Anatera Inc, Frisco, TX (US)

(21) Appl. No.: 17/502,511

(22) Filed: Oct. 15, 2021

Related U.S. Application Data
(60) Provisional application No. 63/138,888, filed on Jan. 19, 2021.

(51) Int. Cl. G07C 5/06; G06Q 10/06; G06F 9/445

(52) U.S. Cl. CPC G07C 5/06; G06Q 50/30; G06F 9/44526; G06Q 10/0639

(57) ABSTRACT

A computer-implemented centralized rating system for evaluating driver's performance using one or more passenger data is disclosed. The system comprises a computing device having a processor and a memory in communication with the processor, a database in communication with the computing device, and one or more user device in communication with the computing device via a network, wherein one user device is associated with a driver and another user device is associated with a passenger. The system monitors the movements of the driver along with one or more passengers in a vehicular navigation mode of transport. The system captures the accelerometer and generates synchronized timestamps as well as the accelerometer readings from the user device of the driver and passengers. The system further comprises a system-created metrics for capturing eccentric and excessive swerves, abrupt, jerky stops, and bumps in driver performance.

### CROSS-REFERENCE TO RELATED APPLICATION

This application claims priority to U.S. Provisional Patent Application No. 63/138,888, titled “RATING SYSTEM FOR DRIVER PERFORMANCE USING PASSENGER DATA” filed on Jan. 19, 2021. The specification of the above referenced patent application is incorporated herein by reference in its entirety.

### BACKGROUND OF THE INVENTION

### A. Technical Field

The present invention generally relates to performance evaluation systems. More specifically, the present invention relates to a rating system that monitors the driver's movements in vehicle navigation mode using passenger data configured to evaluate the driver's performance.

### B. Description of Related Art

Road safety is a major concern that has to be followed at all times to ensure the safety of all road users including vehicle drivers, motorcyclists, bicyclists, and pedestrians. Poor road safety may cause accidents. The causes of accidents include breaking the road rules and bad quality of driving.

Therefore, various measures and methods taken to establish road safety include the use of various road safety products. Well-designed and uniquely engineered road safety products ensure the constant safety of vehicles and pedestrians. These road safety products intimate people about parts of a road they should avoid and accident-prone zones as well as simply organize traffic and vehicles in an orderly manner. Further, accidents could be minimized if road users collectively identify the particular users whose actions may cause inconvenience or pose a hazard to others and inform these users about their behavior by some appropriate means.

In general, the bad driving quality of a driver may cause traffic congestion and even may cause the accident. In addition, a driver with bad driving quality could affect other road users. In some situations, drivers may not be aware of their driving mistakes and their quality of driving. Improving the driving quality of drivers is good for improving the safety of all road users. There are systems developed to provide feedback based on the data received from sensing devices. However, these systems are generally expensive and do not provide a human level of assessment on every aspect of driving depending on the current traffic conditions.

In particular, providing feedback message on each aspect of driving instantly or at an appropriate time may be useful to identify the driving aspect that needs to be improved and well-performed driving aspects. Further, if a system provides an appropriate user interface to easily identify the vehicle involved in the violation, collect appropriate data automatically, and provide an appropriate interface based on the current conditions may be useful for a user to send appropriate messages related to the performance of a driver.

For instances, Uber and its competitors have redefined the way of travel from point A to point B in modern times. The popularity and the need for these services have given rise to a number of rating systems for both the drivers and users. Unfortunately, most of these rating systems are user-reported and may or may not be a reliable indicator of the driver's driving performance. In some cases, users may rate a driver low or high due to considerations other than their actual driving performance. In some cases, there are some drivers drive very erratically and cause headaches for their passengers but surprisingly have good ratings. This indicates the rating system used by current apps does not include or consider all components of a driving experience correctly. While there are attempts to capture the behavioral aspects with specific categorical user-reported ratings, however there is no specific rating for capturing erratic driving directly from the system.

In light of all the above-mentioned drawbacks, there is a need for an improved and reliable machine-generated driving rating system configured to monitor and evaluate the driving performance of a drive using one or more passenger data.

### SUMMARY OF THE INVENTION

The present invention generally discloses performance evaluation systems. Further, the present invention discloses a rating system that monitors the driver's movements in vehicle navigation mode using one or more passenger data configured to evaluate the driver's performance.

According to the present invention, the rating system is implemented in a computer-implemented environment configured to monitor and rate the driver's performance. In one embodiment, the system comprises one or more user devices, wherein each user device is associated with the user. In one embodiment, the user is a driver and one or more passengers. In one embodiment, one user device is associated with the driver and another user device is associated with the passenger. In one embodiment, the user device is at least any one of a smartphone, a mobile phone, a tablet, a laptop, and/or other suitable handheld electronic communication devices.

In one embodiment, the system further comprises a network and a centralized rating management system or central system. In one embodiment, the user device is enabled to access the centralized rating management system via the network. In one embodiment, the user device comprises a storage medium in communication with the network to access the centralized rating management system. In an embodiment, the network could be Wi-Fi, WiMAX, wireless local area network (WLAN), satellite networks, cellular networks, private networks, and the like.

In one embodiment, the centralized rating management system comprises a computing device and a database in communication with the computing device. In one embodiment, the computing device could be a cloud server. The server is configured to collect one or more parameters from the user device. In one embodiment, the server could be operated as a single computer. In some embodiments, the computer could be a touchscreen and/or non-touchscreen and adopted to run on any type of OS, such as iOS™ Windows™, Android™, Unix™, Linux™, and/or others. In one embodiment, the database is accessible by the computing device. In another embodiment, the database is integrated into the computing device or separate from it. In some embodiments, the database resides in a connected server or in a cloud computing service. Regardless of location, the database comprises a memory to store and organize certain data for use by the computing device.

In one embodiment, the computing device comprises a processor and a memory unit in communication with the processor. The memory unit stores a set of instructions executable by the processor. The memory unit could be RAM, ROM (including EPROM, EEPROM, and PROM). In one embodiment, the user devices are configured to access the services provided by the computing device via the network. In one embodiment, the computing device is configured to provide communication between the drivers and the passengers in the form of ratings.

In one embodiment, the user device is configured to connect to the computing device via the network using agent applications executed in a computer-implemented environment or network environment. In one embodiment, the agent application could be any one of an application software or mobile application or web-based application. In one embodiment, the system receives input data such as eccentric and excessive swerves, abrupt, jerky stops, and bumps in driver performance from the user device associated with one or more passengers.

In one embodiment, the computer-implemented environment further comprises a system-created metrics for capturing eccentric and excessive swerves, abrupt, jerky stops, and bumps in driver performance. In one embodiment, the system is configured to monitor the movements of the driver along with one or more passengers in a vehicular navigation mode of transport. In one embodiment, the system is further configured to capture the accelerometer data from the user device of the driver and passengers. In one embodiment, the system is further configured to generate synchronized timestamps as well as the accelerometer readings from the user device of the driver and passengers.

In one embodiment, the system is configured to monitor the movements of the driver along with one or more passengers in a vehicular navigation mode of transport. In one embodiment, the system is further configured to capture the accelerometer data from the user device of the driver and passengers. In one embodiment, the system is further configured to generate synchronized timestamps as well as the accelerometer readings from the user device of the driver and passengers. Each accelerometer reading at every instant has an x, y, z component, and a trace along each dimension. In one embodiment, the x-dimension of the swerve is defined as an excessive lateral movement on the road perpendicular to the direction of the car within a specified time window. In one embodiment, the y-dimension is the direction of movement of the car long which the car is moving in each of the accelerometer data. In one embodiment, the z-dimension is a direction along which there is very little motion such as the vertical motion relative to the elevation of the underlying road.

In one embodiment, the system utilizes a swerve measure that defines an excessive lateral deviation swerving from positive to negative and back, or vice versa, in a dimension perpendicular to the direction of travel within a specified time window, a stop measure that indicates the movement along the dimension aligned with the direction of travel, and a bump measure that indicates movement along the vertical dimension. In one embodiment, the system further utilizes one or more synchronous swerve factors or synchronous-x measures, one or more synchronous stop factors or synchronous-y measures, and one or more synchronous bump factors or synchronous-z measures. In one embodiment, the each of the synchronous-x measures is normalized for each segment of the trip such as local road, highway, and freeway by dividing the corresponding numbers for those durations to scale to unit duration to create unit-measures. In one embodiment, the unit-measures for the driver are compared with the unit measures for other drivers to create a t-score (from a population of such measures) for each segment for the driver (t-score is used here as per its traditional definition in statistics: https://en.wikipedia.org/wiki/Standard_score)

Other objects, features and advantages of the present invention will become apparent from the following detailed description. It should be understood, however, that the detailed description and the specific examples, while indicating specific embodiments of the invention, are given by way of illustration only, since various changes and modifications within the spirit and scope of the invention will become apparent to those skilled in the art from this detailed description.

### BRIEF DESCRIPTION OF DRAWINGS

The foregoing summary, as well as the following detailed description of the invention, is better understood when read in conjunction with the appended drawings. For the purpose of illustrating the invention, exemplary constructions of the invention are shown in the drawings. However, the invention is not limited to the specific methods and structures disclosed herein. The description of a method step or a structure referenced by a numeral in a drawing is applicable to the description of that method step or structure shown by that same numeral in any subsequent drawing herein.

FIG. 1 shows a rating system implemented in a computer-implemented environment in one embodiment of the present invention.

FIG. 2 shows a graph representing the driving performance of a driver with passenger data in one embodiment of the present invention.

### DETAILED DESCRIPTION OF EMBODIMENTS

A description of embodiments of the present invention will now be given with reference to the Figures. It is expected that the present invention may be embodied in other specific forms without departing from its spirit or essential characteristics. The described embodiments are to be considered in all respects only as illustrative and not restrictive.

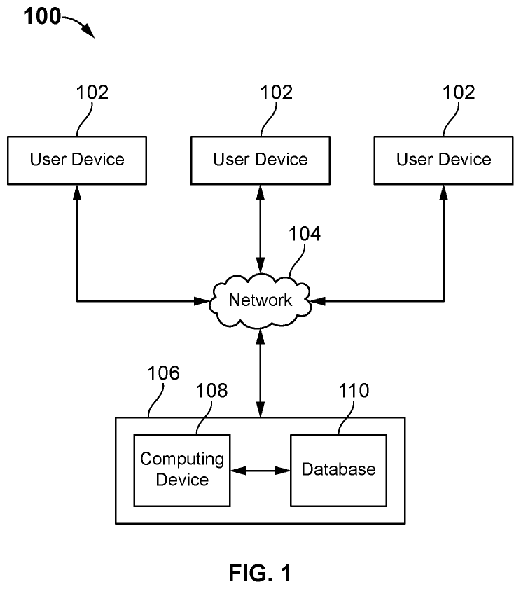

Referring to FIG. 1, a rating system implemented in a computer-implemented environment 100 configured to monitor and rate the driver performance, in one embodiment of the present invention. In one embodiment, the system comprises one or more user devices 102, wherein each user device 102 is associated with the user. In one embodiment, the user is a driver and one or more passengers. In one embodiment, one user device is associated with the driver and another user device is associated with the passenger. In one embodiment, the user device 102 is at least any one of a smartphone, a mobile phone, a tablet, a laptop, and/or other suitable handheld electronic communication devices.

In one embodiment, the system further comprises a network 104 and a centralized rating management system or central system 106. In one embodiment, the user device 102 is enabled to access the centralized rating management system 106 via the network 104. In one embodiment, the user device 102 comprises a storage medium in communication with the network 104 to access the centralized rating management system 106. In an embodiment, the network 104 could be Wi-Fi, WiMAX, wireless local area network (WLAN), satellite networks, cellular networks, private networks, and the like.

In one embodiment, the centralized rating management system 106 comprises a computing device 108 and a database 110 in communication with the computing device 108. In one embodiment, the computing device 108 could be a cloud server. The server is configured to collect one or more parameters from the user device 102. In one embodiment, the server could be operated as a single computer. In some embodiments, the computer could be a touchscreen and/or non-touchscreen and adopted to run on any type of OS, such as iOS™, Windows™, Android™, Unix™, Linux™, and/or others. In one embodiment, the plurality of computers is in communication with each other, via networks. Such communication is established via any one of a software application, a mobile application, a browser, an OS, and/or any combination thereof. In one embodiment, the database 110 is accessible by the computing device 108. In another embodiment, the database 110 is integrated into the computing device 108 or separate from it. In some embodiments, the database 110 resides in a connected server or in a cloud computing service. Regardless of location, the database 110 comprises a memory to store and organize certain data for use by the computing device 108.

In one embodiment, the computing device 108 comprises a processor and a memory in communication with the processor. The memory stores a set of instructions executable by the processor. The memory may be RAM, ROM (including EPROM, EEPROM, and PROM). In one embodiment, the user devices 102 are configured to access the services provided by the computing device 108 via the network 104. In one embodiment, the computing device 108 is configured to provide communication between the drivers and the passengers in the form of ratings.

In one embodiment, the user device 102 is configured to connect to the computing device 108 via the network 104 using agent applications executed in a computer-implemented environment or network environment 100. In one embodiment, the agent application could be any one of a software application or a mobile application or web-based application. In one embodiment, the system receives input data such as eccentric and excessive swerves, abrupt, jerky stops, and bumps in driver performance from the user device associated with one or more passenger. In one embodiment, the computer-implemented environment 100 further comprises a system-created metrics for capturing eccentric and excessive swerves, abrupt, jerky stops, and bumps in driver performance. In one embodiment, the system is configured to monitor the movements of the driver along with one or more passengers in a vehicular navigation mode of transport. In one embodiment, the system is further configured to capture the accelerometer data from the user device of the driver and passengers. In one embodiment, the system is further configured to generate synchronized timestamps as well as the accelerometer readings from the user device of the driver and passengers.

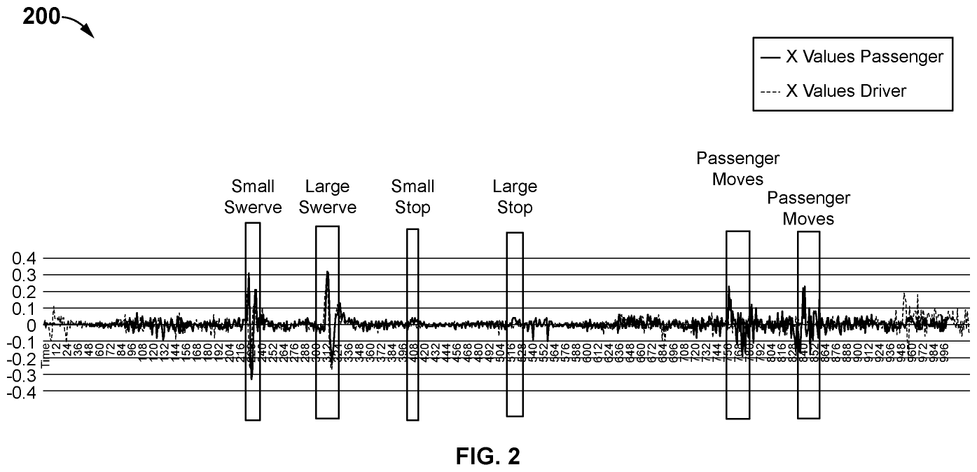

Referring to FIG. 2, a graph 200 representing the driving performance of a driver with one or more passenger data, according to one embodiment of the present invention. In one embodiment, the system receives input data such as eccentric and excessive swerves, abrupt, jerky stops, and bumps in driver performance from the user device 102 associated with the passengers. In one embodiment, the user device 102 is configured to connect to the computing device 108 via the network 104 using agent applications executed in a computer-implemented environment or network environment 100. In one embodiment, the agent application could be any one of an application software or mobile application or web-based application. The agent application generates synchronized timestamps as well as the accelerometer readings from both devices (driver's user device and passenger's user device). In one embodiment, the application that connects to the central server or computing device 108 measures the synchronous swerves that is attributable to the driver.

In one embodiment, the system is configured to monitor the movements of the driver along with one or more passengers in a vehicular navigation mode of transport. In one embodiment, the system is further configured to capture the accelerometer data from the user device of the driver and passengers. In one embodiment, the system is further configured to generate synchronized timestamps as well as the accelerometer readings from the user device of the driver and passengers. Each accelerometer reading at every instant has an x, y, z component, and a trace along each dimension. In one embodiment, the x-dimension of the swerve is defined as an excessive lateral movement on the road perpendicular to the direction of the car within a specified time window. In one embodiment, the y-dimension is the direction of movement of the car long which the car is moving in each of the accelerometer data. In one embodiment, the z-dimension is a direction along which there is very little motion such as the vertical motion relative to the elevation of the underlying road. During rating process, the passenger is relatively stable; sitting in a vehicle and the driver's mobile is relatively stable, possibly fixed in a position most of the time.

In one embodiment, the system utilizes a swerve measure, a stop measure, and a bump measure. In one embodiment, the swerve measure defines an excessive lateral deviation swerving from positive to negative and back, or vice versa, in a dimension perpendicular to the direction of travel within a specified time window, as measured by the agent application that uses the accelerometer. For example, if the phone is held straight the x-dimension should capture the swerve factor. In one embodiment, the stop measure indicates the movement along the dimension aligned with the direction of travel.

For example, if the phone is held straight the y-dimension should capture smoothness factor. In one embodiment, the bump measure indicates movement along the vertical dimension, perpendicular to the x and y dimensions. For example, if the phone is held straight the z-dimension should capture the bump factor.

In one embodiment, the system further utilizes one or more synchronous swerve factors or synchronous-x measures, one or more synchronous stop factors or synchronous-y measures, and one or more synchronous bump factors or synchronous-z measures. In one embodiment, the one or more synchronous swerve could be, but not limited to, driver, passenger, travel time t, and map m. In one embodiment, the synchronous swerve could be defined as the number of swerves in time-partitioned windows of the travel, wherein the deviations are not aligned with the deviation of the underlying map where both the passenger and the driver register a ‘swerve’ in the same time window.

In one embodiment, the one or more synchronous stop could be, but not limited to, driver, passenger, travel time t, and map m. In one embodiment, the synchronous stop could be defined as the number of swerves in time-partitioned windows of the travel, wherein the deviations are not aligned with the deviation of the underlying map where both the passenger and the driver register a ‘stop’ (lagged by a small-delta1) in the same time window.

In one embodiment, the one or more synchronous bump could be, but not limited to, driver, passenger, travel time t, and map m. In one embodiment, the synchronous bump could be defined as the number of swerves in time-partitioned windows of the travel, wherein the deviations may be aligned with the artifacts such as speed bumps, potholes of the underlying map, where both the passenger and the driver register a ‘bump’ (passenger data shifted by a small delta2) in the same time window.

In one embodiment, each of the synchronous-x measures is normalized for each segment of the trip such as local road, highway, and freeway by dividing the corresponding numbers for that duration to scale to unit duration to create unit measures. In one embodiment, the unit measures for the driver are compared with the unit measures for other drivers to create a t-score for each segment for the drive. In another embodiment, the synchronous measures could be compared with the performance of other drivers within the same segments of the roads and normalized and t-scored.

In one embodiment, a driving jerk rating measure for a driver for a new trip could be calculated by identifying the amount of local roads, highways, and freeways in the new trip and doing a corresponding weighted combination of the t-score measures for synchronous-swerve, synchronous-stop and synchronous-bump factors. In another embodiment, a simple-jerk rating could be measured as a simple weighted combination based on the known ratio of local roads, highways, and freeways within the city or region of travel.

In one embodiment, a driver smoothness rating could be returned as an inverse (x-jerk) of the specific jerk rating for the driver. In another embodiment, the scores also incorporate a multitude of passengers travelling in the same vehicle and the rating is sublinearly accentuated by the performance of the driver across the rest of the passengers.

Further, the rating system is a machine-generated reliable driving rating system is designed to be effective in the application configured to monitor and evaluate the driving performance of the driver using one or more passenger data. The user benefits from improved ease of use and improved rating system, which could provide considerable market interest in the product.

Preferred embodiments of this invention are described herein, including the best mode known to the inventors for carrying out the invention. It should be understood that the illustrated embodiments are exemplary only and should not be taken as limiting the scope of the invention.

The foregoing description comprises illustrative embodiments of the present invention. Having thus described exemplary embodiments of the present invention, it should be noted by those skilled in the art that the within disclosures are exemplary only, and that various other alternatives, adaptations, and modifications may be made within the scope of the present invention. Merely listing or numbering the steps of a method in a certain order does not constitute any limitation on the order of the steps of that method. Many modifications and other embodiments of the invention will come to mind to one skilled in the art to which this invention pertains having the benefit of the teachings in the foregoing descriptions. Although specific terms may be employed herein, they are used only in generic and descriptive sense and not for purposes of limitation. Accordingly, the present invention is not limited to the specific embodiments illustrated herein.

1. A computer-implemented centralized rating system for rating driver performance, comprising:
a computing device having a processor and a memory in communication with the processor, wherein the memory having a software module and a set of instructions executable by the processor;
wherein the software module is at least one of a plug-in component and/or a browser extension, or a software application;
one or more user devices in communication with the computing device via a network, wherein at least one user device is associated with a driver and another user device is associated with a passenger;
a database in communication with the server configured to store data related to users and drivers, wherein the database comprising one or more program modules, which are executed by the processor, thereby causing the computing device and user devices to perform multiple operations, comprising:
enabling one or more users to access the centralized rating management system using the user device via the network;
allowing the users to send input data from the user device,
wherein the input data is related to eccentric and excessive swerves, abrupt, jerky stops, and bumps;
monitoring the movements of the driver along with one or more passengers in a vehicular navigation mode of transport;
capturing accelerometer data from the user device associated with the driver and passengers;
generating synchronized timestamps and accelerometer readings from the user device associated with the driver and passengers, and
a system-created metrics configured to capture the input data from the user devices associated with passengers for evaluating the driver performance.

2. The rating system of claim 1, wherein the computing device is configured to measure the synchronous swerves that is attributable to the driver.

3. The rating system of claim 1, wherein the accelerometer data at every instant has an x, y, z component and a trace along each dimension.

4. The rating system of claim 1, is further configured to utilize a swerve measure that defines an excessive lateral deviation swerving from positive to negative and back, or vice versa, in a dimension perpendicular to the direction of travel within a specified time window.

5. The rating system of claim 1, is further configured to utilize a stop measure that indicates the movement along the dimension aligned with the direction of travel.

6. The rating system of claim 1, is further configured to utilize a bump measure that indicates movement along the vertical dimension.

7. The rating system of claim 1, is further configured to utilize one or more synchronous swerve factors or synchronous-x measures, one or more synchronous stop factors or synchronous-y measures, and one or more synchronous bump factors or synchronous-z measures for evaluating the driver performance.

8. The rating system of claim 1, wherein each of the synchronous-x measures is normalized for each segment of the trip such as local road, highway, and freeway by dividing the corresponding numbers for those durations to scale to unit duration to create unit-measures.

9. The rating system of claim 8, wherein the unit-measures for the driver are compared with the unit measures for other drivers to create a t-score for each segment for the driver.

10. The rating system of claim 1, wherein the computer-implemented centralized system is a machine-generated reliable driving rating system designed to be effective in the application configured to monitor and evaluate the driving performance of the driver using the input data provided by the passengers.

11. The rating system of claim 1, wherein the scores incorporate a multitude of passengers travelling in the same vehicle and the rating is sublinearly accentuated by the performance of the driver across the rest of the passengers.

12. The rating system of claim 1, is further configured to utilize a driving jerk rating measure for measuring jerks for a trip by identifying the amount of local roads, highways and freeways in the trip and also performing a corresponding weighted combination of the t-score measures for synchronous swerve, synchronous stop, and synchronous bump factors.

13. The rating system of claim 1, is further configured to provide a driver smoothness rating for passengers, wherein the driver smoothness rating is returned as an inverse of the specific jerk rating for the driver.

14. The rating system of claim 1, wherein the computing device and the user device are at least any one of a smartphone, a mobile phone, a tablet, a laptop, and/or other suitable handheld electronic communication devices.

15. The rating system of claim 1, wherein the network is at least any one of Wi-Fi, WiMAX, wireless local area network (WLAN), satellite networks, cellular networks, and private networks.
